(19) United States
(12) Patent Application Publication
(10) Pub. No.: US 2023/0376035 A1
(43) Pub. Date: Nov. 23, 2023

(54) METHOD AND SYSTEM FOR OPERATING ON-DEMAND VEHICLE

(71) Applicant: Woven by Toyota, Inc., Tokyo (JP)

(72) Inventors: Koki MATSUSHITA, Tokyo-to (JP); Ryota NAKABAYASHI, Nagoya-shi (JP); Motoaki UMAKOSHI, Nagoya-shi (JP); Rika OIKE, Shizuoka-shi (JP)

(73) Assignee: Woven by Toyota, Inc., Tokyo (JP)

(21) Appl. No.: 18/318,095

(22) Filed: May 16, 2023

(30) Foreign Application Priority Data
May 17, 2022 (JP) 2022-081009

(51) Int. Cl. G05D 1/00; G05D 1/02; G06Q 10/02; G06Q 10/0631

(52) U.S. Cl. CPC G05D 1/0088; G05D 1/021; G06Q 10/02; G06Q 10/06311; G05D 2201/0213

(57) ABSTRACT

The method of the present disclosure is a method for operating an on-demand vehicle that travels by autonomous driving on a single lane on which a regular service vehicle is operated. According to the method of the present disclosure, first the on-demand vehicle is moved to a meeting place with a user in response to receiving a reservation for the on-demand vehicle from the user. Next, an available waiting time of the on-demand vehicle at the meeting place is calculated based on a regular operation schedule of the regular service vehicle. Then, the on-demand vehicle is moved from the meeting place so as not to affect operation of the regular service vehicle when the available waiting time elapses without the user appearing at the meeting place.

### CROSS-REFERENCE TO RELATED APPLICATION

The present application claims priority under 35 U.S.C. § 119 to Japanese Patent Application No. 2022-081009, filed May 17, 2022, the contents of which application are incorporated herein by reference in their entirety.

### BACKGROUND

### Field

The present disclosure relates to a method and system for operating an on-demand vehicle that travels by autonomous driving in a single lane in which a regular service vehicle is operated.

### Background Art

JP2018-060372A discloses a prior art related to operation of an on-demand vehicle. JP2018-060372A discloses estimating a time at which a user arrives at a place to board a transportation vehicle, and correcting an operation schedule of the transportation vehicle when the estimated arrival time is not in time a scheduled boarding time.

In addition to JP2018-060372A, JP2019-158843A, JP2005-018697A, and JP2013-186541A can be exemplified as documents showing the technical level of the technical field related to the present disclosure.

### SUMMARY

It has been studied to use the site of a track of a single railway line as a single lane. In addition, in areas where land is limited in the first place, it may be possible to secure only a single lane even if a lane is built. On the other hand, at present, mobility-as-a-service using vehicles traveling by autonomous driving has been studied in various fields. Autonomous driving vehicles for mobility-as-a-service include on-demand vehicles that are operated in accordance with requests from users.

When mobility-as-a-service is more generally developed in society, it is assumed that there will be a need to operate on-demand vehicles that travel autonomously in a single lane in which regular service vehicles are operating. However, none of the prior art documents listed above discloses a method for operating an on-demand vehicle traveling by autonomous driving in a single lane in which a regular service vehicle is operated.

The present disclosure has been made in view of the above-described problems. An object of the present disclosure is to provide a technique capable of operating an on-demand vehicle that travels by autonomous driving in a single lane in which a regular service vehicle is operated without interfering with the operation of the regular service vehicle.

In order to achieve the above objective, the present disclosure provides an on-demand vehicle operating method and an on-demand vehicle operating system as an on-demand vehicle operating technique.

The on-demand vehicle operating method of the present disclosure is a method for operating an on-demand vehicle that travels by autonomous driving on a single lane on which a regular service vehicle is operated. The on-demand vehicle operating method of the present disclosure comprises the following steps. The first step is to move the on-demand vehicle to a meeting place with a user in response to receiving a reservation for the on-demand vehicle from the user. The second step is to calculate an available waiting time of the on-demand vehicle at the meeting place based on a regular operation schedule of the regular service vehicle. The third step is to move the on-demand vehicle from the meeting place so as not to affect operation of the regular service vehicle when the available waiting time elapses without the user appearing at the meeting place.

The on-demand vehicle operation system of the present disclosure is a system for operating an on-demand vehicle that travels by autonomous driving on a single lane on which a regular service vehicle is operated. The on-demand vehicle operating system of the present disclosure comprises at least one processor and a program memory coupled to the at least one processor and storing a plurality of executable instructions. The plurality of executable instructions is configured to cause the at least one processor to execute the following processes. The first process is to move the on-demand vehicle to a meeting place with a user in response to receiving a reservation for the on-demand vehicle from the user. The second process is to calculate an available waiting time of the on-demand vehicle at the meeting place based on a regular operation schedule of the regular service vehicle. Then, the third process is to move the on-demand vehicle from the meeting place so as not to affect operation of the regular service vehicle when the available waiting time elapses without the user appearing at the meeting place.

According to the on-demand vehicle operating technique of the present disclosure, it is possible to prevent the on-demand vehicle from interfering with the operation of the regular service vehicle on the single lane where the number of overtaking places is limited while maximally considering the user who is delayed in arrival at the meeting place.

In the on-demand vehicle operating technique of the present disclosure, an operation schedule for picking up the next user after picking up the previous user may be created in response to receiving a reservation for the on-demand vehicle from the next user. In this case, the available waiting time for the previous user may be calculated based on the regular operation schedule of the regular service vehicle on condition that the minimum waiting time required for the next user to board the on-demand vehicle is secured at the meeting place with the next user. Accordingly, in a case where the on-demand vehicle also picks up the next user, it is possible to prevent the next user from suffering a disadvantage due to the previous user who does not appear at the meeting place.

In the on-demand vehicle operating technology of the present disclosure, the user may be notified of moving the on-demand vehicle from the meeting place when the available waiting time elapses without the user appearing at the meeting place. According to this, the on-demand vehicle is prevented from leaving the meeting place while the user does not know, suppressing a decrease in the user's satisfaction with the on-demand vehicle service.

In the on-demand vehicle operating technique of the present disclosure, a plurality of overtaking places including a stop of the regular service vehicle may be provided on a single lane. In this case, the moving the on-demand vehicle from the meeting place may comprise moving the on-demand vehicle to a nearest overtaking place where the on-demand vehicle can reach before the regular service vehicle passes through. This allows the on-demand vehicle to be passed over by the regular service vehicle with minimum travel.

In the on-demand vehicle operating technique of the present disclosure, the on-demand vehicle may be moved to the meeting place again after the regular service vehicle passes the on-demand vehicle at the nearest overtaking place. According to this, it is possible to relieve the user whose arrival at the meeting place is delayed.

In the on-demand vehicle operating technology of the present disclosure, the user may be notified of moving the on-demand vehicle from the meeting place when the available waiting time elapses without the user appearing at the meeting place. In this case, the on-demand vehicle may be moved to the meeting place again subject to a request for re-dispatch from the user. According to this, the user who intends to use the on-demand vehicle is relieved, and wasteful operation of the on-demand vehicle is reduced.

As described above, according to the on-demand vehicle operating technique of the of the present disclosure, the on-demand vehicle can be operated without interfering with the operation of the regular service vehicle on the single lane on which the number of overtaking places is limited while maximally considering the user who is delayed in arrival at the meeting place.

### BRIEF DESCRIPTION OF THE DRAWINGS

FIG. 1 is a diagram illustrating an outline of a vehicle operation system according to an embodiment of the present disclosure.

FIG. 2 is a block diagram illustrating a configuration of the vehicle operation system according to an embodiment of the present disclosure.

FIG. 3 is a diagram illustrating a first example of a vehicle operation method according to an embodiment of the present disclosure.

FIG. 4 is a diagram illustrating the first example of the vehicle operation method according to an embodiment of the present disclosure.

FIG. 5 is a diagram illustrating a second example of the vehicle operation method according to an embodiment of the present disclosure.

FIG. 6 is a diagram illustrating a third example of the vehicle operation method according to an embodiment of the present disclosure.

FIG. 7 is a diagram illustrating the third example of the vehicle operation method according to an embodiment of the present disclosure.

FIG. 8 is a diagram illustrating a fourth example of the vehicle operation method according to an embodiment of the present disclosure.

### DETAILED DESCRIPTION

### 1. Outline of Vehicle Operation System

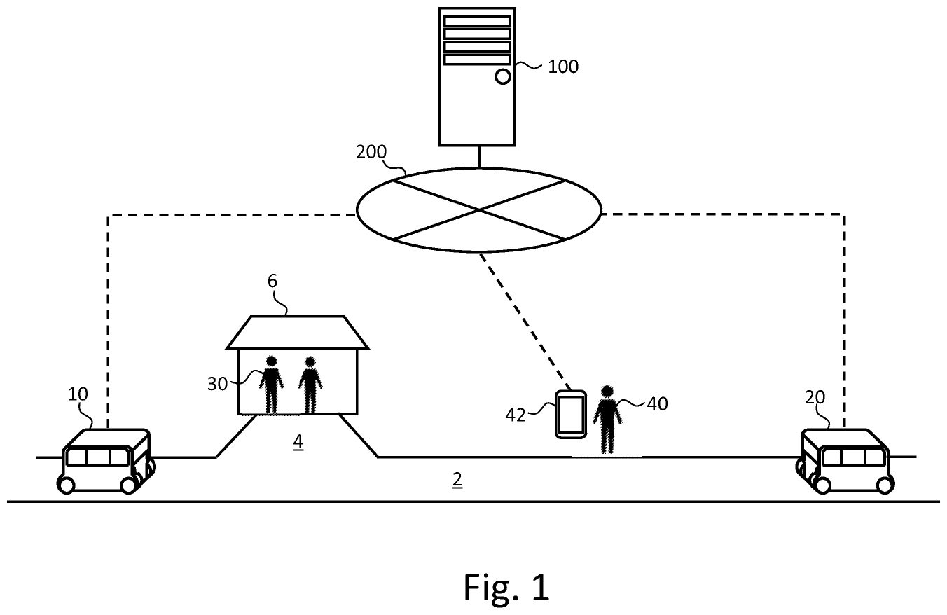

FIG. 1 is a diagram illustrating an outline of a vehicle operation system according to an embodiment of the present disclosure. The operation system is a system for operating vehicles 10 and 20 on a single-lane line 2. The single-lane line 2 is, for example, a line built on the site of a single railway line. On the single-lane line 2, two vehicles 10 and 20 cannot travel side by side or pass by each other. For this reason, the single-lane line 2 is provided with a plurality of overtaking places for allowing vehicles 10 and 20 to overtake each other and pass each other.

The overtaking place includes at least one stop 4. If the single-lane line 2 is constructed in the site of a railway line, the stop 4 corresponds to a railway station. Even in the case of a single railway line, the station is constructed so that a train traveling on the forward path and a train traveling on the return path can pass each other. Thus, the stop 4 diverted from the station allows two vehicles 10 and 20 to pass each other and overtake each other. A waiting house 6 is set up at the stop 4 as a waiting place for a user 30. The overtaking places other than the stop 4 provided on the single-lane line 2 are places for only passing and overtaking for vehicles 10 and 20, and the waiting house 6 is not provided.

The vehicles 10 and 20 operated by the operation system are a regular service vehicle 10 and an on-demand vehicle 20. The regular service vehicle 10 is a vehicle that is regularly operated in accordance with a regular operation schedule. The on-demand vehicle 20 is a vehicle that does not have a fixed operation schedule and is operated in response to a request from a user. In addition, the on-demand vehicle 20 is also a ride-sharing vehicle that sequentially picks up users who wish to ride together. In the operation system, autonomous driving vehicles that travel by autonomous driving are used as the regular service vehicle 10 and the on-demand vehicle 20.

Management of operation of the regular service vehicle 10 which is an autonomous driving vehicle is performed by an operation management server 100. In addition, management of operation of the on-demand vehicle 20 which is an autonomous driving vehicle is also performed by the operation management server 100. The regular service vehicle 10 and the on-demand vehicle 20 are connected to the operation management server 100 via a network 200.

Both the regular service vehicle 10 and the on-demand vehicle 20 may be an electric vehicle, an engine vehicle, or a hybrid vehicle. The electric vehicle mentioned here includes not only a vehicle equipped with a battery or a fuel cell but also a vehicle that takes in electricity from a pantograph, such as an electric train. Further, both vehicles 10 and 20 are not limited to vehicles with tires, and may be vehicles traveling on tracks such as trains. In this case, the regular service vehicle 10 may be an automatically driven train such as a streetcar in a city, and the on-demand vehicle 20 may be an autonomously driven automobile.

The user 30 is a user who uses the regular service vehicle 10. The user 30 boards the regular service vehicle 10 from the stop 4. The regular service vehicle 10 stops at the stop 4 according to the regular operation schedule. The user 40 is a user who uses the on-demand vehicle 20. The user 40 can call the on-demand vehicle 20 not only at the stop 4 but also anywhere near the single-lane line 2. The user 40 reserves dispatch of the on-demand vehicle 20 using a mobile terminal 42 represented by a smartphone. The reservation for dispatching the on-demand vehicle 20 is made to the operation management server 100. The operation management server 100 specifies a place where the user 40 waits using the position information of the mobile terminal 42.

### 2. Configuration of Vehicle Operation System

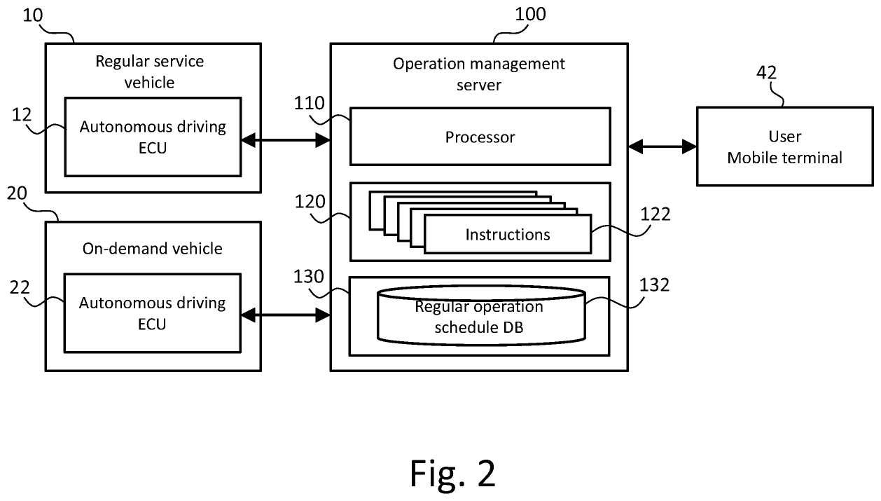

FIG. 2 is a block diagram illustrating a configuration of the vehicle operation system according to an embodiment of the present disclosure. The operation system includes the operation management server 100. The operation management server 100 includes at least one processor (hereinafter simply referred to as a processor) 110, a program memory 120, and a storage 130. The processor 110 is coupled to the program memory 120 and the storage 130. The program memory 120 may be a non-transitory memory that stores executable instructions 122. The storage 130 is, for example, a flash memory, an SSD, or an HDD, and stores a regular operation schedule database 132.

The operation management server 100 communicates with an autonomous driving ECU 12 of the regular service vehicle 10 and transmits instructions including the operation schedule of the regular service vehicle 10 to the autonomous driving ECU 12. The operation schedule of the regular service vehicle 10 is determined in accordance with the regular operation schedule registered in the regular operation schedule database 132. These processes are executed by the operation management server 100 when predetermined instructions 122 are executed by the processor 110.

The operation management server 100 communicates with an autonomous driving ECU 22 of the on-demand vehicle 20 and transmits instructions including the operation schedule of the on-demand vehicle 20 to the autonomous driving ECU 22. The operation schedule of the on-demand vehicle 20 is determined with reference to the regular operation schedule registered in the regular operation schedule database 132 based on a dispatch request for the on-demand vehicle 20 from the user 40. These processes are executed by the operation management server 100 when predetermined instructions 122 are executed by the processor 110.

The operation management server 100 communicates with the mobile terminal 42 of the user 40. The operation management server 100 receives, from the portable terminal 42, a dispatch request for reserving the dispatch of the on-demand vehicle 20 from the user 40 and position information of the user 40. The operation management server 100 transmits, to the mobile terminal 42, a notification for notifying completion of reservation of dispatching the on-demand vehicle 20 and position information for notifying a position where the on-demand vehicle 20 is currently traveling. These processes are executed by the operation management server 100 when predetermined instructions 122 are executed by the processor 110.

In the next section, the operation method of the on-demand vehicle 20 executed by the operation management server 100 will be described using specific examples.

### 3. Method of Operating On-Demand Vehicle

### 3-1. Premise

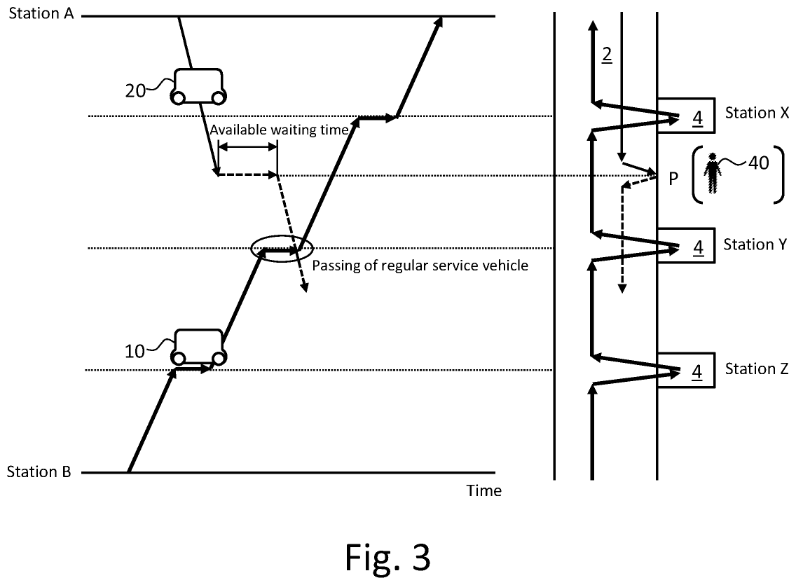

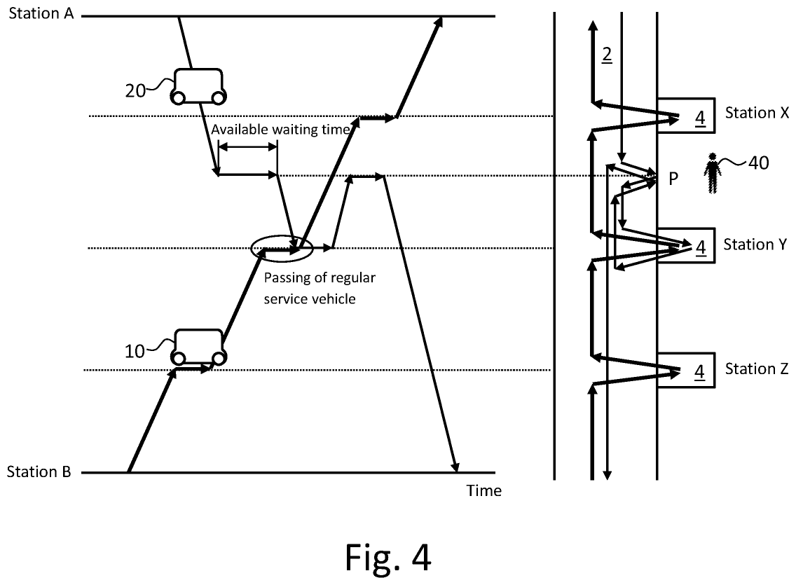

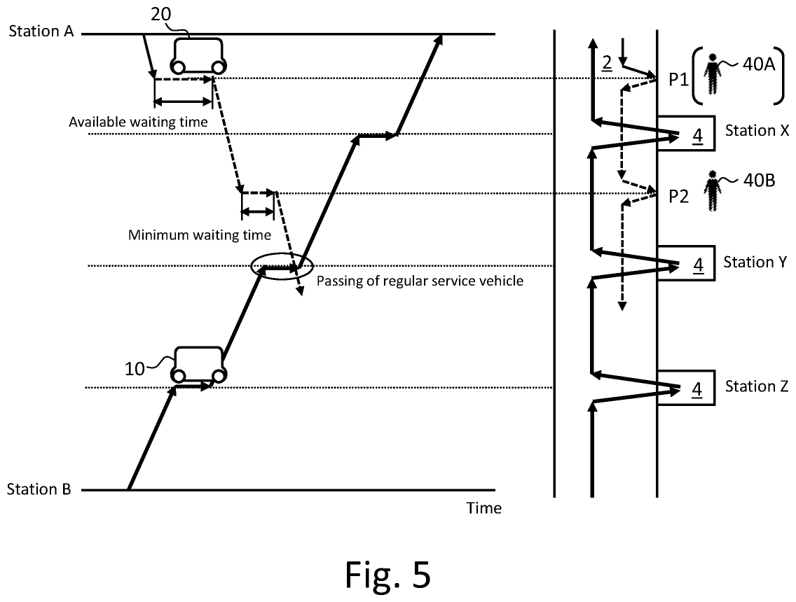

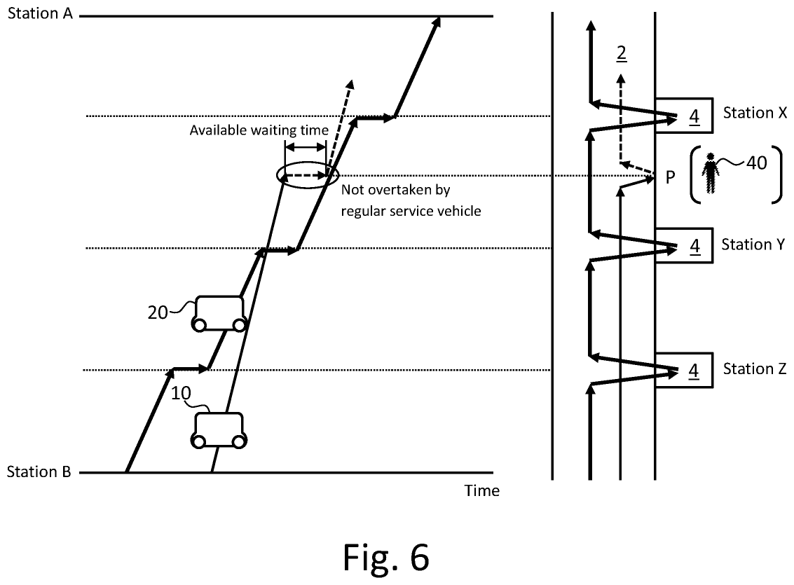

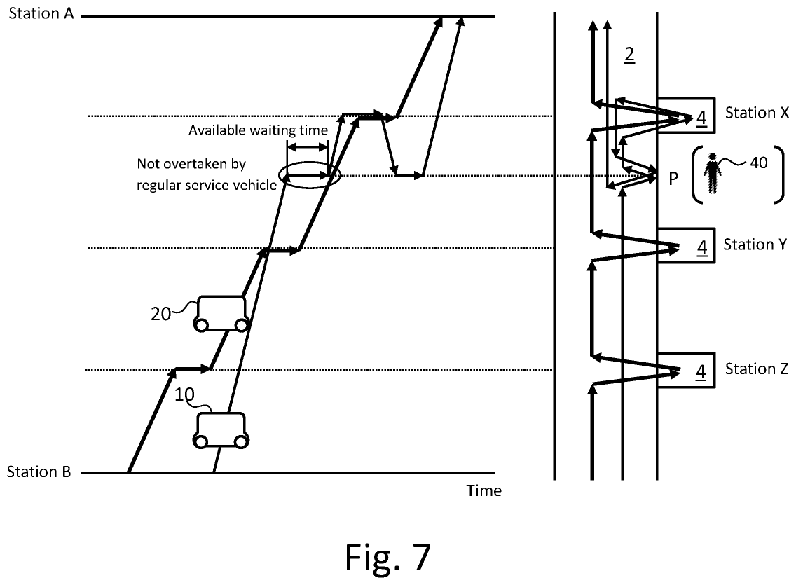

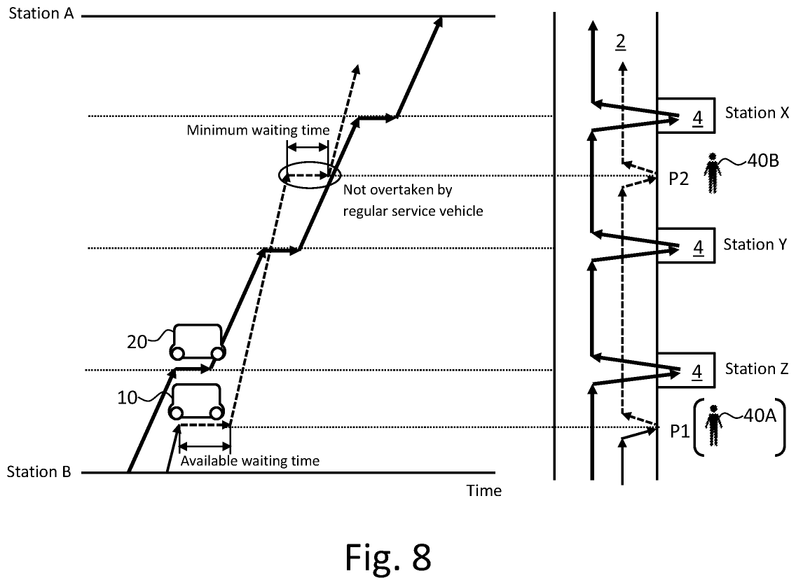

FIGS. 3 and 4 are diagrams illustrating a first example of the operation method of the on-demand vehicle 20. FIG. 5 is a diagram illustrating a second example of the operation method of the on-demand vehicle 20. FIGS. 6 and 7 are diagrams illustrating a third example of the operation method of the on-demand vehicle 20. FIG. 8 is a diagram illustrating a fourth example of the operation method of the on-demand vehicle 20. The left side of each figure is a schedule of each of vehicles 10 and 20, and the right side of each figure shows the movement of each of vehicles 10 and 20 on the single-lane line 2. Hereinafter, a premise in each example will be described.

In each example, the single-lane line 2 is a line connecting Station A and Station B. On the single-lane line 2, three stations, that is, Station X, Station Y, and Station Z are provided in this order between Station A and Station B. These three stations are stops 4 provided in the single-lane line 2. In order to simplify the description, the overtaking places provided on the single-lane line 2 are only three stops 4. Further, in each example, only one regular service vehicle 10 is operated between Station A and Station B at a time, and only one on-demand vehicle 20 is operated between Station A and Station B at a time.

In each example, the regular service vehicle 10 is operated from Station B to Station A. The regular service vehicle 10 travels in accordance with the regular operation schedule and stops at all the stations that are stops 4 in order. The stop time of the regular service vehicle 10 at each stop 4 is determined in the regular operation schedule.

The on-demand vehicle 20 is operated from Station A to Station B or from Station B to Station A. It is assumed that the on-demand vehicle 20 can make a U-turn on the way. However, the single-lane line 2 has few places where vehicles can turn. Therefore, the on-demand vehicle 20 is preferably a vehicle capable of traveling in both forward and backward directions. It is assumed that the on-demand vehicle 20 stops at a meeting place with the user 40, that is, a place where the on-demand vehicle 20 picks up the user 40.

### 3-2. First Example

In the first example shown in FIGS. 3 and 4, after the regular service vehicle 10 leaves Station B, the user 40 makes a reservation for the on-demand vehicle 20. The meeting place P desired by the user 40 is located between Station X and Station Y. The user 40 wants to go from the meeting place P to Station B. Therefore, the on-demand vehicle 20 waiting at Station A becomes a vehicle to be dispatched to the user 40.

As shown in FIG. 3, the operation management server 100 that has received the reservation from the user 40 creates an operation schedule for moving the on-demand vehicle 20 to the meeting place P, picking up the user 40, and then directing the on-demand vehicle 20 to Station B. To create the operation schedule of the on-demand vehicle 20, the regular operation schedule of the regular service vehicle 10 is referred to. On the single-lane line 2, two vehicles can pass each other only at the stop 4. In addition, when the regular service vehicle 10 and the on-demand vehicle 20 are operated on the single-lane line 2, the operation of the regular service vehicle 10 having a large influence on users should be prioritized. Therefore, the operation schedule of the on-demand vehicle 20 is created so that the on-demand vehicle 20 passes through the stop 4 while the regular service vehicle 10 stops at the stop 4 in accordance with the regular operation schedule.

When the operation schedule of the on-demand vehicle 20 can be created, the operation management server 100 notifies the user 40 of approval of the reservation. In addition, the operation management server 100 notifies the user 40 of the created operation schedule of the on-demand vehicle 20 together with the approval notification of the reservation. As means for notifying the user 40, for example, a message transmitted from the operation management server 100 to the mobile terminal 42 is used. The message includes the position of the meeting place P and the arrival time of the on-demand vehicle 20 at the meeting place P (hereinafter referred to as the meeting time).

Further, the message includes the latest departure time of the on-demand vehicle 20 from the meeting place P (hereinafter, referred to as a limit departure time) or the available waiting time of the on-demand vehicle 20 at the meeting place P. The available waiting time is a maximum time during which the on-demand vehicle 20 can wait at the meeting place P without causing a problem in the operation of the regular service vehicle 10. In the first example, the on-demand vehicle 20 is scheduled to pass by the regular service vehicle 10 at Station Y ahead of the meeting place P. Therefore, if the on-demand vehicle 20 does not arrive at Station Y before the departure time at which the regular service vehicle 10 departs from Station Y, the departure of the regular service vehicle 10 is hindered. The limit departure time is the latest departure time from the meeting place P at which the on-demand vehicle 20 can arrive at Station Y before the regular service vehicle 10 departs from Station Y. The operation management server 100 calculates the available waiting time at the meeting place P from the meeting time at the meeting place P and the limit departure time from the meeting place P.

However, the available waiting time must be longer than the minimum waiting time. The minimum waiting time is a time required for the on-demand vehicle 20 to arrive, the user 40 to board the on-demand vehicle 20, and the on-demand vehicle 20 to depart. In a case where the available waiting time longer than the minimum waiting time cannot be secured, the operation schedule of the on-demand vehicle 20 cannot be created. In this case, the operation management server 100 notifies the user 40 of the disapproval of the reservation. At this time, if an available waiting time longer than the minimum waiting time can be secured by changing the meeting place P or changing the meeting time, the operation management server 100 proposes an alternative to the user 40.

The minimum waiting time is set on the assumption that the user 40 is a person who requires time to board, such as an elderly person or a disabled person. However, when the user 40 makes a reservation, the user 40 may be caused to input a profile of the user 40 or a passenger, and the minimum waiting time may be set based on the input profile. In a case where the minimum waiting time is determined to be able to set short from the input profile, the operation management server 100 creates an operation schedule of the on-demand vehicle 20 with a short available waiting time.

The operation management server 100 notifies the user 40 of a reminder a predetermined time before the meeting time. The user 40 can arbitrarily set the number of times and the time for notifying the reminder. When the user 40 boards the on-demand vehicle 20 at the meeting place P, the on-demand vehicle 20 notifies the operation management server 100 that the user 40 has boarded the on-demand vehicle 20. As a method of authenticating the boarding of the user 40 into the on-demand vehicle 20, for example, a method of performing authentication by short-range wireless communication between the mobile terminal 42 of the user 40 and the on-demand vehicle 20 can be used.

When the boarding of the user 40 in the on-demand vehicle 20 is not confirmed even after the meeting time, the operation management server 100 notifies the user 40 of an alarm. The alarm is notified a predetermined time before the limit departure time. The user 40 can arbitrarily set the number of times and the time for notifying the alarm. When a plurality of users 40 are scheduled to board the on-demand vehicle 20 at the meeting place P, confirmation of boarding and notification of an alarm are performed for each user 40.

FIG. 4 illustrates an operation example of the on-demand vehicle 20 in a case where the user 40 does not appear at the meeting place P even at the limit departure time. In this case, the operation management server 100 causes the on-demand vehicle 20 to depart toward Station Y which is the nearest overtaking place at the time point when the limit departure time arrives. Then, the on-demand vehicle 20 and the regular service vehicle 10 are caused to pass each other at Station Y. When causing the on-demand vehicle 20 to depart from the meeting place P, the operation management server 100 notifies the user 40 who has not appeared at the meeting place P of moving the on-demand vehicle 20 from the meeting place P. This allows the user 40 who has received the notification to know the reason why the on-demand vehicle 20 is not at the meeting place P, thereby suppressing a decrease in the satisfaction degree of the user 40 with respect to the on-demand vehicle service.

The user 40 whose arrival at the meeting place P is delayed can request the operation management server 100 to dispatch the on-demand vehicle 20 again. This is to relieve the user 40 who intends to use the on-demand vehicle 20 and to reduce wasteful operation of the on-demand vehicle 20. Whether or not the on-demand vehicle 20 can be dispatched again depends on, for example, the presence or absence of another user who is scheduled to board the on-demand vehicle 20, the meeting time with another user, the regular operation schedule of the regular service vehicle 10, the presence or absence of interference with the operation schedule of another on-demand vehicle, and the like. When the on-demand vehicle 20 cannot be dispatched again, the operation management server 100 notifies the user 40 of the fact.

When the on-demand vehicle 20 can be dispatched again, the operation management server 100 recreates an operation schedule for the on-demand vehicle 20 to return to the meeting place P, pick up the user 40, and depart again toward Station B. When creating the operation schedule, the operation management server 100 sets the meeting time at the meeting place P so that the on-demand vehicle 20 does not catch up with the regular service vehicle 10 that has previously departed from Station Y. After the operation schedule is recreated, the operation management server 100 transmits to the user 40 a message including information on the position of the meeting place P, the meeting time, and the limit departure time from the meeting place P (or the available waiting time at the meeting place P).

The operation management server 100 instructs the on-demand vehicle 20 to return from Station Y to the meeting place P. When the user 40 is confirmed to board the on-demand vehicle 20 at the meeting place P, the operation management server 100 instructs the on-demand vehicle 20 to depart toward Station B.

### 3-3. Second Example

In a second example shown in FIG. 5, after the regular service vehicle 10 leaves Station B, reservations are made for the on-demand vehicle 20 from the user 40A and the user 40B. The meeting place P1 desired by the user 40A is located between Station A and Station X. The meeting place P2 desired by the user 40B is located between Station X and the Station Y. The users 40A and 40B both want to go to Station B. Therefore, the on-demand vehicle 20 waiting at Station A are dispatched as a ride-sharing vehicle for the users 40A and 40B.

The operation management server 100 creates an operation schedule of the on-demand vehicle 20. In the operation schedule, first, the on-demand vehicle 20 is moved to the meeting place P1 with the user 40A. After the user 40A is picked up, the on-demand vehicle 20 is moved to the meeting place P2 with the user 40B, and after the user 40B is picked up, the on-demand vehicle 20 is moved to Station B. To create the operation schedule of the on-demand vehicle 20, the regular operation schedule of the regular service vehicle 10 is referred to. In the example shown in FIG. 5, the places where the on-demand vehicle 20 can pass the regular service vehicle 10 are only Station X and Station Y. However, if the on-demand vehicle 20 is caused to pass the regular service vehicle 10 at Station X, the arrival times of the users 40A and 40B at Station B, which is the destination, are greatly delayed. Therefore, the operation management server 100 creates an operation schedule of the on-demand vehicle 20 so that the on-demand vehicle 20 passes the regular service vehicle 10 at Station Y.

When the operation schedule of the on-demand vehicle 20 can be created, the operation management server 100 notifies the users 40A and 40B of approval of the reservation. In addition, the operation management server 100 notifies the users 40A and 40B of the created operation schedule of the on-demand vehicle 20 together with the approval notification of the reservation. The message notified to the user 40A includes the position of the meeting place P1, the meeting time, and the limit departure time from the meeting place P1 (or the available waiting time at the meeting place P1). The message notified to the user 40B includes the position of the meeting place P2, the meeting time, and the limit departure time from the meeting place P2. However, while the time at which the on-demand vehicle 20 arrives at the meeting place P1 is determined by the operation schedule, the time at which the on-demand vehicle 20 arrives at the meeting place P2 depends on the departure time from the meeting place P1. Therefore, the user 40B is notified of the arrival time when the on-demand vehicle 20 arrives at the meeting place P2 earliest as the meeting time.

In the second example, the operation management server 100 calculates the limit departure time and the available waiting time at the meeting place P1 in consideration of the minimum waiting time at the meeting place P2. That is, the on-demand vehicle 20 is required to arrive at Station Y before the regular service vehicle 10 departs from Station Y and to wait at the meeting place P2 for at least the minimum waiting time as conditions for operation. The latest departure time from the meeting place P1 that can satisfy these conditions is the limit departure time at the meeting place P1, and the maximum waiting time that can satisfy these conditions is the available waiting time at the meeting place P1.

When the minimum waiting time cannot be secured in both the meeting place P1 and the meeting place P2, only one of the users 40A and 40B can board the on-demand vehicle 20. In this case, the operation management server 100 notifies only the user who requests for the reservation of the on-demand vehicle 20 first of the approval of the reservation, and notifies the user who requests for the reservation later of the disapproval of the reservation.

The operation management server 100 notifies the user 40A of a reminder a predetermined time before the meeting time at the meeting place P1. When the boarding of the user 40A in the on-demand vehicle 20 is not confirmed even after the meeting time, the operation management server 100 notifies the user 40A of an alarm. When the user 40A does not appear at the meeting place P1 even when the limit departure time is finally reached, the operation management server 100 causes the on-demand vehicles 20 to depart toward the next meeting place P2 at the time point when the limit departure time is reached. When causing the on-demand vehicle 20 to depart from the meeting place P1, the operation management server 100 notifies the user 40A who has not appeared at the meeting place P1 of moving the on-demand vehicle 20 from the meeting place P1.

In the example illustrated in FIG. 5, the user 40A cannot request the operation management server 100 to dispatch the on-demand vehicle 20 again. In order to dispatch the on-demand vehicle 20 to the user 40A again, it is necessary to cause the on-demand vehicle 20 and the regular service vehicle 10 to pass each other at Station Y after the next user 40B boards the on-demand vehicle 20, and then return the on-demand vehicle 20 to the meeting place P1. Such an operation has a great disadvantage for the user 40B and cannot be adopted. Therefore, in a case where the on-demand vehicle 20 is used as a ride-sharing vehicle, the on-demand vehicle 20 is not caused to make a U-turn to dispatch again to a user who has missed a ride, at least unless there is consent of another user.

### 3-4. Third Example

In the third example shown in FIGS. 6 and 7, after the regular service vehicle 10 leaves Station B, the user 40 makes a reservation for the on-demand vehicle 20. The meeting place P desired by the user 40 is located between Station X and Station Y. The user 40 wants to go from the meeting place P to Station A. Therefore, the on-demand vehicle 20 waiting at Station B becomes a vehicle to be dispatched to the user 40.

As shown in FIG. 6, the operation management server 100 that has received the reservation from the user 40 creates an operation schedule for moving the on-demand vehicle 20 to the meeting place P, picking up the user 40, and then directing the on-demand vehicle 20 to Station A. To create the operation schedule of the on-demand vehicle 20, the regular operation schedule of the regular service vehicle 10 is referred to. Since the on-demand vehicle 20 is faster than the regular service vehicle 10, the on-demand vehicle 20 can catch up with the regular service vehicle 10 that has departed earlier on the way. On the single-lane line 2, however, passing between vehicles is possible only at stop 4. Therefore, the operation management server 100 causes the on-demand vehicle 20 to pass through Station Y before the meeting place P while the regular service vehicle 10 is stopped at Station Y. That is, the operation management server 100 causes the on-demand vehicle 20 to overtake the regular service vehicle 10 at Station Y.

When the operation schedule of the on-demand vehicle 20 can be created, the operation management server 100 notifies the user 40 of approval of the reservation. In addition, the operation management server 100 notifies the user 40 of the created operation schedule of the on-demand vehicle 20 together with the approval notification of the reservation. The message notified to the user 40 includes the position of the meeting place P, the meeting time, and the limit departure time from the meeting place P (or the available waiting time at the meeting place P).

In the third example, the regular service vehicle 10 departs from Station Y after the on-demand vehicle 20. While the on-demand vehicle 20 is waiting at the meeting place P, the regular service vehicle 10 approaches the meeting place P. When the regular service vehicle 10 catches up with the on-demand vehicle 20, the regular service vehicle 10 cannot overtake the on-demand vehicle 20 unless a place where the regular service vehicle 10 catches up with the on-demand vehicle 20 is an overtaking place. In this case, the regular service vehicle 10 is forced to decelerate, and a delay occurs in the operation schedule of the regular service vehicle 10.

The limit departure time in the third example is a departure at which the on-demand vehicle 20 is not caught up by the regular service vehicle 10 that departs from Station Y later. The limit departure time is determined based on the time at which the regular service vehicle 10 passes through the meeting place P. For example, a time that is a predetermined time before the time at which the regular service vehicle 10 passes through the meeting place P is set as the limit departure time. Alternatively, the limit departure time is set so that the on-demand vehicle 20 is caused to depart at a time point at which the regular service vehicle 10 reaches a point at a predetermined distance from the meeting place P. The predetermined time and the predetermined distance are set in consideration of a delay in departure of the on-demand vehicle 20 and a delay in acceleration after the departure. The operation management server 100 calculates the available waiting time at the meeting place P from the meeting time at the meeting place P and the limit departure time from the meeting place P.

When the available waiting time longer than the minimum waiting time cannot be secured, the operation management server 100 notifies the user 40 of disapproval of the reservation. At this time, if an available waiting time longer than the minimum waiting time can be secured by changing the meeting place P or changing the meeting time, the operation management server 100 proposes an alternative to the user 40.

The operation management server 100 notifies the user 40 of a reminder a predetermined time before the meeting time at the meeting place P. When the boarding of the user 40 in the on-demand vehicle 20 is not confirmed even after the meeting time, the operation management server 100 notifies the user 40 of an alarm.

FIG. 7 illustrates an operation example of the on-demand vehicle 20 in a case where the user 40 does not appear at the meeting place P even at the limit departure time. In this case, the operation management server 100 causes the on-demand vehicle 20 to depart toward Station X which is the nearest overtaking place at the time point when the limit departure time arrives. Then, the on-demand vehicle 20 and the regular service vehicle 10 are caused to pass each other at Station X. Although Station X and Station Y are substantially equidistant from the meeting place P, the regular service vehicle 10 is already heading from Station Y to the meeting place P. Therefore, it is not possible to cause the on-demand vehicle 20 to depart toward Station Y. However, if the on-demand vehicle 20 can reach Station Y before the regular service vehicle 10 departs from Station Y, Station Y can be set as the overtaking place. The operation management server 100 notifies the user 40 who has not appeared at the meeting place P of moving the on-demand vehicle 20 from the meeting place P.

The user 40 whose arrival at the meeting place P is delayed can request the operation management server 100 to dispatch the on-demand vehicle 20 again. When the on-demand vehicle 20 can be dispatched again, the operation management server 100 recreates an operation schedule for the on-demand vehicle 20 to return to the meeting place P, pick up the user 40, and depart again toward Station A. When creating the operation schedule, the operation management server 100 sets the departure time from the meeting place P so that the on-demand vehicle 20 does not catch up with the regular service vehicle 10 that has previously departed from Station X toward Station A. After the operation schedule is recreated, the operation management server 100 transmits to the user 40 a message including information on the position of the meeting place P, the meeting time, and the departure time from the meeting place P.

The operation management server 100 instructs the on-demand vehicle 20 to return from Station X to the meeting place P. When the user 40 is confirmed to board the on-demand vehicle 20 at the meeting place P, the operation management server 100 instructs the on-demand vehicle 20 to depart toward Station B.

### 3-5. Fourth Example

In the fourth example shown in FIG. 8, after the regular service vehicle 10 leaves Station B, reservations are made for the on-demand vehicle 20 from the user 40A and the user 40B. The meeting place P1 desired by the user 40A is located between Station B and Station Z. The meeting place P2 desired by the user 40B is located between Station X and the Station Y. The users 40A and 40B both want to go to station A. Therefore, the on-demand vehicle 20 waiting at Station B are dispatched as a ride-sharing vehicle for the users 40A and 40B.

The operation management server 100 creates an operation schedule of the on-demand vehicle 20. In the operation schedule, first, the on-demand vehicle 20 is moved to the meeting place P1 with the user 40A. After the user 40A is picked up, the on-demand vehicle 20 is moved to the meeting place P2 with the user 40B, and after the user 40B is picked up, the on-demand vehicle 20 is moved to Station A. To create the operation schedule of the on-demand vehicle 20, the regular operation schedule of the regular service vehicle 10 is referred to. In the example shown in FIG. 8, the place where the on-demand vehicle 20 can overtake the regular service vehicle 10 is only Station Y. The operation management server 100 creates an operation schedule of the on-demand vehicle 20 so that the on-demand vehicle 20 overtakes the regular service vehicle 10 at Station Y.

When the operation schedule of the on-demand vehicle 20 can be created, the operation management server 100 notifies the users 40A and 40B of approval of the reservation. In addition, the operation management server 100 notifies the users 40A and 40B of the created operation schedule of the on-demand vehicle 20 together with the approval notification of the reservation. The contents of the messages notified to the users 40A and 40B are the same as those in the second example.

In the second example, the operation management server 100 calculates the limit departure time and the available waiting time at the meeting place P1 in consideration of the minimum waiting time at the meeting place P2. That is, the on-demand vehicle 20 is required to depart from the meeting place P2 before being caught up by the regular service vehicle 10 and to wait at the meeting place P2 for at least the minimum waiting time as conditions for operation. The latest departure time from the meeting place P1 that can satisfy these conditions is the limit departure time at the meeting place P1, and the maximum waiting time that can satisfy these conditions is the available waiting time at the meeting place P1.

When the minimum waiting time cannot be secured in both the meeting place P1 and the meeting place P2, only one of the users 40A and 40B can board the on-demand vehicle 20. In this case, the operation management server 100 notifies only the user who requests for the reservation of the on-demand vehicle 20 first of the approval of the reservation, and notifies the user who requests for the reservation later of the disapproval of the reservation.

The operation management server 100 notifies the user 40A of a reminder a predetermined time before the meeting time at the meeting place P1. When the boarding of the user 40A in the on-demand vehicle 20 is not confirmed even after the meeting time, the operation management server 100 notifies the user 40A of an alarm. When the user 40A does not appear at the meeting place P1 even when the limit departure time is finally reached, the operation management server 100 causes the on-demand vehicles 20 to depart toward the next meeting place P2 at the time point when the limit departure time is reached. When causing the on-demand vehicle 20 to depart from the meeting place P1, the operation management server 100 notifies the user 40A who has not appeared at the meeting place P1 of moving the on-demand vehicle 20 from the meeting place P1.

### 3-6. Effect

In the above-described four specific examples, when the available waiting time elapses without the user 40 appearing at the meeting place, the on-demand vehicle 20 is moved from the meeting place so as not to affect the operation of the regular service vehicle 10. By operating the on-demand vehicle 20 in this way, it is possible to prevent the on-demand vehicle 20 from interfering with the operation of the regular service vehicle 10 on a single lane in which overtaking places are limited while maximally considering the user 40 whose arrival at the meeting place is delayed.

### 4. Others

In the four specific examples of the above embodiment, all the overtaking places are stops, but overtaking places other than stops may be included. However, a stop is preferable as a place where the regular service vehicle 10 waits for the on-demand vehicle 20 to pass by. This is because there is a possibility that a passenger gets on the stopped regular service vehicle 10. On the other hand, when the on-demand vehicle 20 waits for the regular service vehicle 10 to pass by, the on-demand vehicle 20 may wait at any overtaking place including a stop.

The autonomous driving ECU 22 of the on-demand vehicle 20 may be included as a component of the operation system. In this case, the at least one processor means the processor 110 of the operation management server 100 and the processor of the autonomous driving ECU 22. In this case, the plurality of instructions means instructions stored in the program memory 120 of the operation management server 100 and instructions stored in the program memory of the autonomous driving ECU 22.

What is claimed is:

1. A method for operating an on-demand vehicle that travels by autonomous driving on a single lane on which a regular service vehicle is operated, comprising:
moving the on-demand vehicle to a meeting place with a user in response to receiving a reservation for the on-demand vehicle from the user;
calculating an available waiting time of the on-demand vehicle at the meeting place based on a regular operation schedule of the regular service vehicle; and
moving the on-demand vehicle from the meeting place so as not to affect operation of the regular service vehicle when the available waiting time elapses without the user appearing at the meeting place.

2. The method according to claim 1, further comprising:
creating, in response to receiving a reservation for the on-demand vehicle from a next user, an operation schedule for picking up the next user after picking up the user; and
calculating the available waiting time based on the regular operation schedule of the regular service vehicle on condition that a minimum waiting time required for the next user to board the on-demand vehicle is secured at a next meeting place with the next user.

3. The method according to claim 1, further comprising notifying the user of moving the on-demand vehicle from the meeting place when the available waiting time elapses without the user appearing at the meeting place.

4. The method according to claim 1, wherein
a plurality of overtaking places including a stop of the regular service vehicle are provided on the single lane, and
the moving the on-demand vehicle from the meeting place comprises moving the on-demand vehicle to a nearest overtaking place where the on-demand vehicle can reach before the regular service vehicle passes through.

5. The method according to claim 4, further comprising moving the on-demand vehicle again to the meeting place after the regular service vehicle passes the on-demand vehicle at the nearest overtaking place.

6. The method according to claim 5, further comprising:
notifying the user of moving the on-demand vehicle from the meeting place when the available waiting time elapses without the user appearing at the meeting place; and
moving the on-demand vehicle again to the meeting place subject to a request for dispatching the vehicle again from the user.

7. A system for operating an on-demand vehicle that travels by autonomous driving on a single lane on which a regular service vehicle is operated, comprising:
at least one processor; and
a program memory coupled to the at least one processor and storing a plurality of executable instructions configured to cause the at least one processor to:
move the on-demand vehicle to a meeting place with a user in response to receiving a reservation for the on-demand vehicle from the user;
calculate an available waiting time of the on-demand vehicle at the meeting place based on a regular operation schedule of the regular service vehicle; and
move the on-demand vehicle from the meeting place so as not to affect operation of the regular service vehicle when the available waiting time elapses without the user appearing at the meeting place.

8. The system according to claim 7, wherein the instructions are configured to further cause the at least one processor to:
create, in response to receiving a reservation for the on-demand vehicle from a next user, an operation schedule for picking up the next user after picking up the user; and
calculate the available waiting time based on the regular operation schedule of the regular service vehicle on condition that a minimum waiting time required for the next user to board the on-demand vehicle is secured at a next meeting place with the next user.

9. The system according to claim 7, wherein the instructions are configured to further cause the at least one processor to notify the user of moving the on-demand vehicle from the meeting place when the available waiting time elapses without the user appearing at the meeting place.

10. The system according to claim 7, wherein
a plurality of overtaking places including a stop of the regular service vehicle are provided on the single lane, and
the moving the on-demand vehicle from the meeting place comprises moving the on-demand vehicle to a nearest overtaking place where the on-demand vehicle can reach before the regular service vehicle passes through.

11. The system according to claim 10, wherein the instructions are configured to further cause the at least one processor to move the on-demand vehicle again to the meeting place after the regular service vehicle passes the on-demand vehicle at the nearest overtaking place.

12. The system according to claim 11, wherein the instructions are configured to further cause the at least one processor to:
notify the user of moving the on-demand vehicle from the meeting place when the available waiting time elapses without the user appearing at the meeting place; and
move the on-demand vehicle again to the meeting place subject to a request for dispatching the vehicle again from the user.
